(19) United States
(12) Patent Application Publication
(10) Pub. No.: US 2003/0076441 A1
(43) Pub. Date: Apr. 24, 2003

(54) Visual presentation apparatus

(75) Inventors: Haruo Maeda, Tsushima (JP); Masami Miyata, Nagoya (JP); Yoshihiko Araya, Kariya (JP)

Correspondence Address: Koda & Androlia, Suite 3850, 2029 Century Park East, Los Angeles, CA, 90067, US

(73) Assignee: Elmo Co., Ltd.

(21) Appl. No.: 10/235,308

(22) Filed: Sep. 5, 2002

(30) Foreign Application Priority Data
Oct. 22, 2001 (JP) 2001-322981

(51) Int. Cl. H04N 5/225

(52) U.S. Cl. 348/375

(57) ABSTRACT

A visual presentation apparatus includes a generally rectangular stage on which a material is placed, a video camera for obtaining an image of the material, a camera arm on which the video camera is mounted so that the video camera is located above a central portion of the stage, and an arm mount provided outside one of corners of the stage. The arm has a proximal end pivotally mounted on the arm mount so that the camera arm is caused to pivot substantially along a diagonal of the stage between a first position where the video camera is located above the central portion of the stage and a second position where the camera arm is folded down along the stage. The video camera is located within the stage when the arm assumes the second position.

### BACKGROUND OF THE INVENTION

1. Field of the Invention

This invention relates to a visual presentation apparatus including a stage on which a material such as a chart, diagram, pamphlet, publications, or model is placed, and a video camera mounted on a camera arm so that the video camera is located above a central portion of the stage and taking an image of the material to obtain image signals, which are delivered to an image reproducing unit such as a television, video projector, etc.

2. Description of the Related Art

In conventional visual presentation apparatus of the above-described type, a CCD video camera is generally mounted on a distal end of a camera arm and a proximal end of the arm is mounted on a rear corner of a generally rectangular stage so that the arm is pivotally moved in a direction of the depth of the stage. When an image of the material is obtained, the arm is caused to stand so that the CCD video camera is located above the central portion of the stage. When the visual presentation apparatus is not used, the arm is pivotally moved forward so that the CCD video camera and the camera arm are folded down along the stage.

Since the proximal end of the camera arm is mounted on the corner of the stage in the conventional visual presentation apparatus, an area of the stage on which a material is placed is limited by the proximal end of the camera arm. As a result, a large material cannot be placed on the stage.

Furthermore, the camera arm is pivotally moved when the visual presentation apparatus is folded down, as described above. Accordingly, the CCD video camera projects out of the stage when the camera arm is excessively long. As a result, the visual presentation apparatus cannot be folded down compactly. On the other hand, when the camera arm is excessively short, a sufficient distance cannot be ensured between the CCD video camera and the stage when the camera is positioned above the central portion of the stage. Consequently, a shooting area is reduced.

### SUMMARY OF THE INVENTION

Therefore, an object of the present invention is to provide a visual presentation apparatus which has a large area of the stage on which the material is placed and can be folded down compactly and ensure a sufficient shooting area.

The present invention provides a visual presentation apparatus comprising a generally rectangular stage on which a material is placed, a video camera for obtaining an image of the material, a camera arm on which the video camera is mounted so that the video camera is located above a central portion of the stage, and an arm mount provided outside one of corners of the stage. In this construction, the camera arm has a proximal end pivotally mounted on the arm mount so that the camera arm is caused to pivot substantially along a diagonal of the stage between a first position where the video camera is located above the central portion of the stage and a second position where the camera arm is folded down along the stage. The video camera is located within the stage when the camera arm assumes the second position.

In the above-described visual presentation apparatus, an area of the stage on which the material is placed can be increased since the arm mount is mounted outside the stage. Furthermore, the length of the camera arm can be increased since the camera arm is caused to pivot along the diagonal of the stage. Consequently, the shooting area can be increased.

In a preferred form, the video camera is mounted on the camera arm so as to be rotatable within a plane generally perpendicular to the stage. Consequently, when the video camera, which is directed to the stage in image pickup, is redirected within the plane perpendicular to the stage, the camera arm can be folded down along the stage without becoming bulky.

In another preferred form, the video camera is mounted on the camera arm so as to be rotatable within a plane generally parallel to the stage. Consequently, the camera arm can be folded down with the video camera being adjacent to the stage.

In further another preferred form, the visual presentation apparatus further comprises a switch panel provided at a side of the stage, and said side of the stage has a recess in which the switch panel is accommodated so as to be drawn out. Consequently, the area of the stage on which the material is placed can be prevented from being reduced by the switches.

### BRIEF DESCRIPTION OF THE DRAWINGS

Other objects, features and advantages of the present invention will become clear upon reviewing the following description of an embodiment, made with reference to the accompanying drawings, in which:

FIG. 1 is a perspective view of a visual presentation apparatus of one embodiment in accordance with the present invention;

FIG. 2 is a plan view of the visual presentation apparatus;

FIG. 3 is a perspective view of the visual presentation apparatus with a switch panel having been drawn out;

FIG. 4 is a perspective view of the visual presentation apparatus with a camera mount having been turned;

FIG. 5 is a perspective view of the visual presentation apparatus with the video camera having been turned;

FIG. 6 is a perspective view of the visual presentation apparatus in a folded state; and

FIG. 7 is a plan view of the visual presentation apparatus in the folded state.

### DETAILED DESCRIPTION OF THE INVENTION

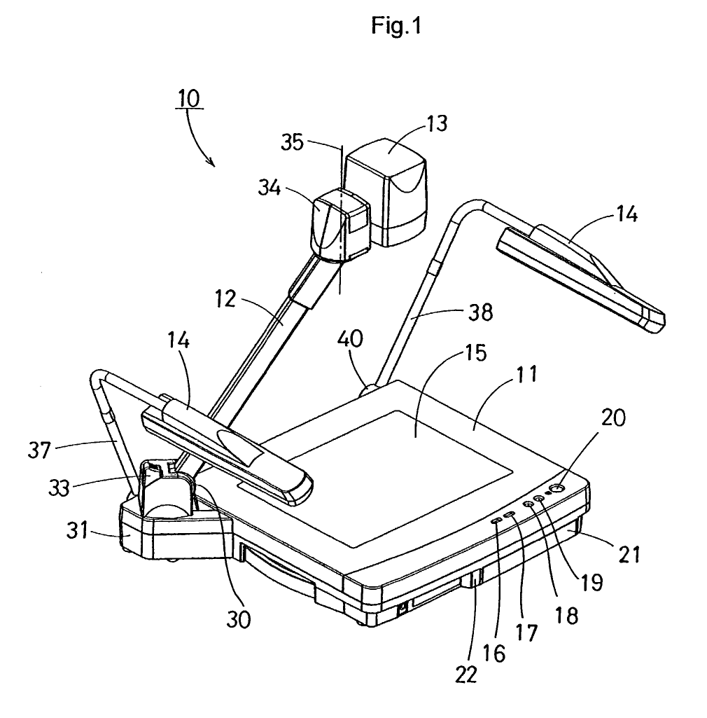

One embodiment of the present invention will be described with reference to the accompanying drawings. Referring to FIG. 1, a visual presentation apparatus 10 in accordance with the invention is shown. The visual presentation apparatus 10 includes a generally square flat box-shaped stage 11, a camera arm 12, a CCD (change-coupled device) camera 13 and a pair of exterior illumination lamps 14 located at opposite sides of the stage.

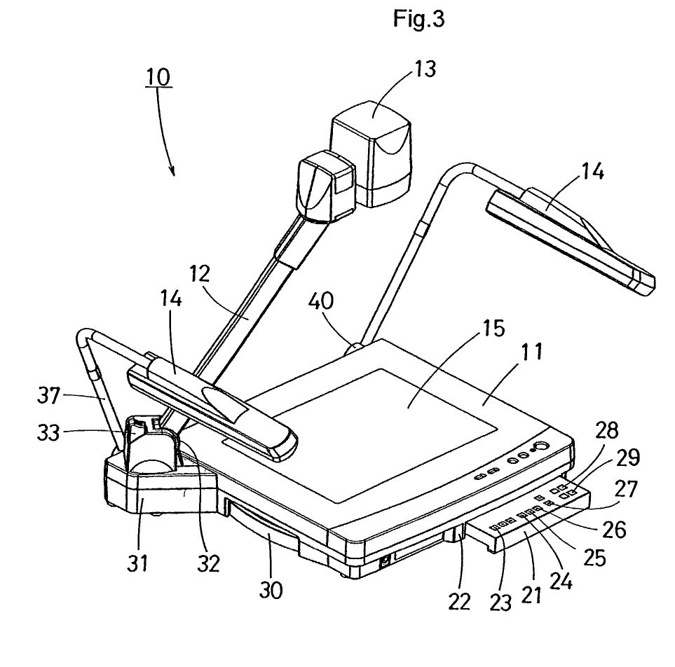

A generally rectangular translucent panel 15 is mounted on a central portion of the stage 11 so as to be substantially coplanar with the stage. An interior illumination lamp (not shown) is disposed in an interior of the stage 11 so as to be located in the rear of the translucent panel 15. Various switches and buttons are provided in a front end of the stage 11. These switches and buttons include an exterior illumination switch 16 for turning on and off the exterior illumination lamps, an interior illumination switch 17 for turning on and off the interior illumination lamp, a scale-down zoom button 18 for zooming an image so that the image is scaled down, a scale-up zoom button 19 for zooming an image so that the image is scaled up, and an auto-focus button 20 for automatically adjust the focus of a image-pickup lens (not shown). These switches and buttons are disposed in a row. The front end of the stage 11 is formed with a recess 22 in which a switch panel 21 is accommodated so as to be drawn out. As shown in FIG. 3, the switch panel 21 includes an input selection button 23 operated in the switch of an input system, an electronic magnification button 24 operated so that an image is doubled in size, a color/B&W selection button 25 operated when an image of black-and-white original such as a document is picked up. The switch panel 21 further includes a negative/positive inversion button 26 operated when a negative film is used, a white balance button 27 for adjusting a conversion point of the white, a manual focus button 28 for manually focusing an image, and an iris button 29 for adjusting screen brightness. A power switch (not shown) is provided on a rear of the stage 11. A carrying handle 30 is mounted on a left-hand end face of the stage 11. When the visual presentation apparatus is carried, a user holds the carrying handle 30 so that the apparatus is hung down.

An arm mount 31 is mounted on the left-hand end face of the stage 11 so as to project outward. The camera arm 12 has a proximal end pivotally mounted on a shaft 32 further mounted on the arm mount 31. Thus, the arm mount 31 is located outside the stage 11. The arm mount 31 is provided with a built-in lock mechanism (not shown) for selectively locking the arm 12 at either standing position or folded position. The arm mount 31 is also provided with a lock release button 33.

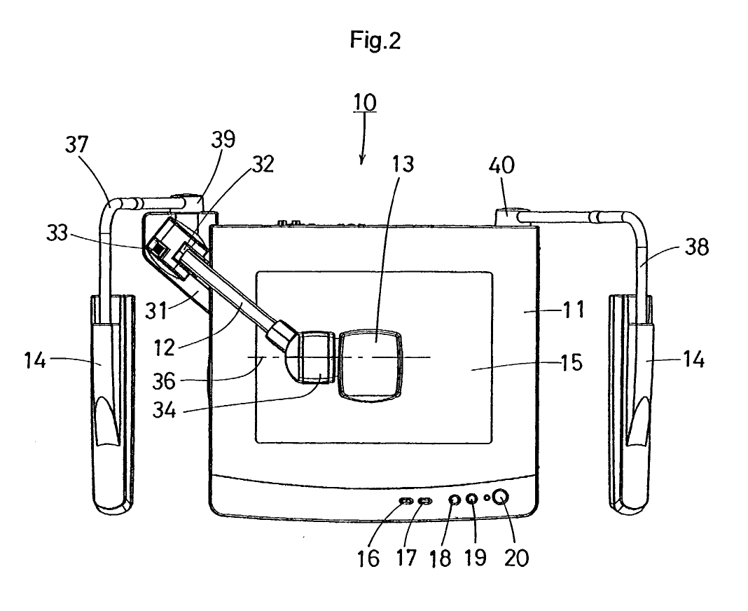

The camera arm 12 has a distal end on which a camera mount 34 is mounted so as to be rotatable about an axis 35 within a plane generally parallel to the stage 11. A CCD video camera 13 is mounted on the camera mount 34 so as to be rotatable about an axis 36 (see FIG. 2) within a plane generally perpendicular to the stage 11. More specifically, the CCD camera 13 is rotatable between a first position where an optical axis of the image-pickup lens is generally perpendicular to the stage 11 and a second position where the image-pickup lens is directed backward and the optical axis of the image-pickup lens is generally parallel to the stage 11. The video camera 13 includes the image-pickup lens and an image sensor such as CCD (charge coupled device) though neither is shown. The video camera 13 is connected to a cord (not shown) which extends through an interior of the camera arm 12 to be connected to an electric circuit (not shown) provided inside the stage 11.

A pair of exterior illumination lamps 14 are mounted on distal ends of two lamp arms 37 and 38 respectively. The lamp arm 37 has a proximal end mounted on a shaft 39 rotatably mounted on a rear end of the arm mount 31. The lamp arm 38 is mounted on a shaft 40 rotatably mounted on a right-hand rear end of the stage 11. Each of the lamp arms 37 and 38 is rotatable between an operative position outside the respective right-hand or left-hand side of the stage 11 and a folded position where the arms 37 and 38 cross each other over the stage 11, as viewed in FIG. 2. Each of the lamp arms 37 and 38 is located outwardly obliquely above the stage 11 when assuming the operative position, whereas each lamp 14 is adjacent to other substantially over the central portion of the stage 11 when assuming the folded position.

The operation of the visual presentation apparatus will now be described. In use, the lamp arms 37 and 38 are firstly moved outward so as to assume the respective operative positions, so that the external illumination lamps 14 are disposed outwardly obliquely above the stage 11 outside the right-hand and left-hand sides of the stage 11 respectively. The camera arm 12 is caused to pivot and locked at the standing position. The camera mount 34 and the CCD video camera 13 are rotated so that the optical axis of the image-pickup lens is generally perpendicular to the stage 11 substantially at the central portion thereof.

A material is then placed on the stage I1 and the power switch and the exterior or interior illumination lamp switch 16 or 17 are operated so that the exterior illumination lamps 14 or interior illumination lamp is turned on, whereby the material is illuminated. The zooming buttons 17 and 18 are operated if necessary, so that a view angle of the image-pickup lens is adjusted. Furthermore, the switch panel 21 is drawn out so that various switches 23 to 29 are operated, if necessary, as shown in FIG. 3.

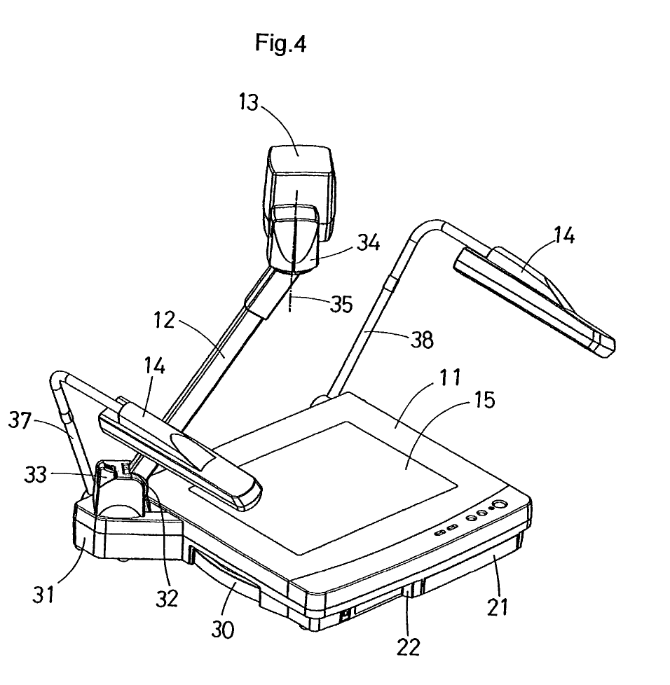

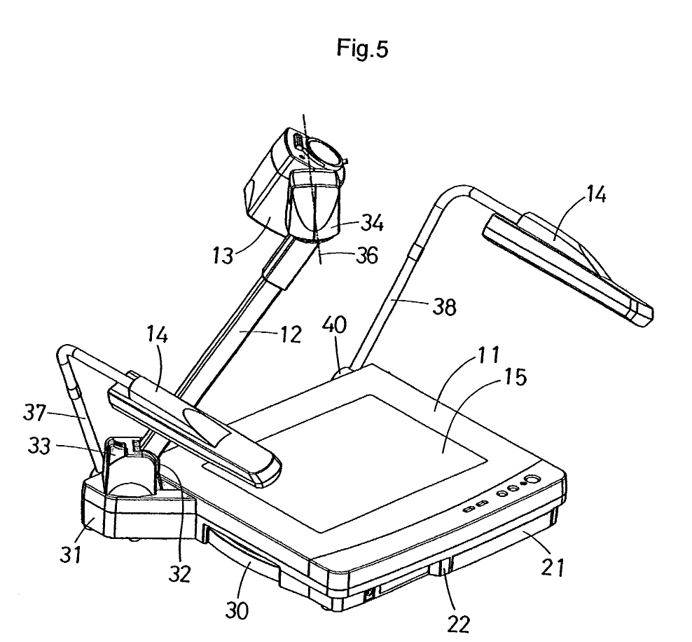

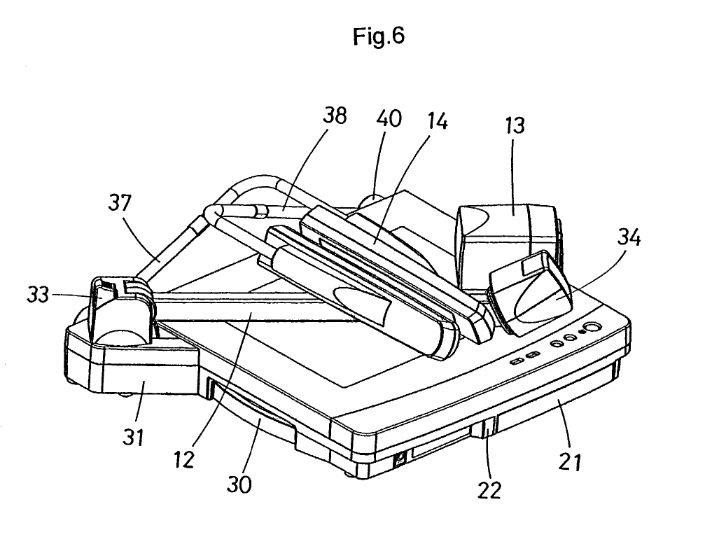

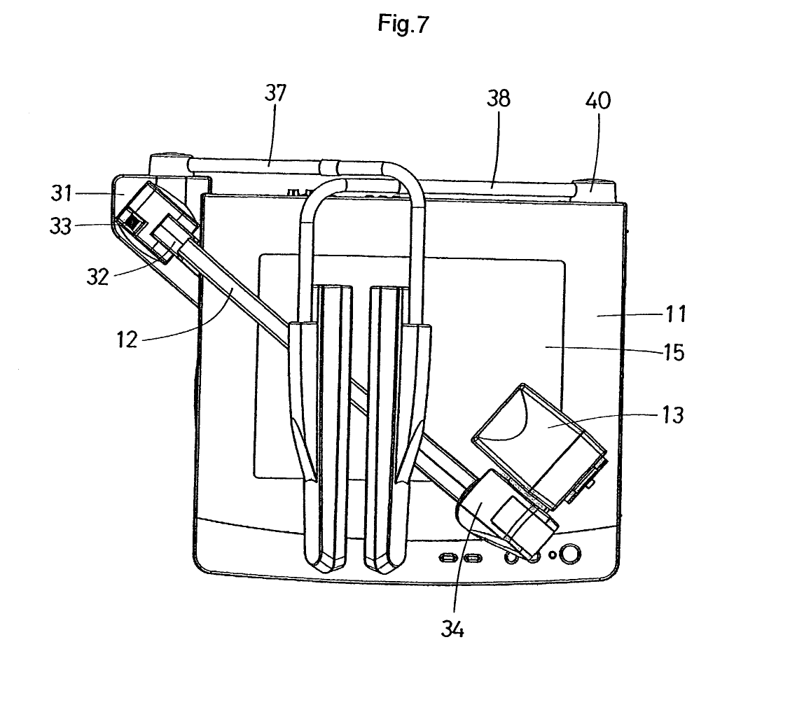

The power switch is turned off when the visual presentation apparatus 10 is not used. The camera mount is then rotated about the axis 35 as shown in FIG. 4. The camera mount is further rotated about the axis 36 as shown in FIG. 5 and the lock release button 33 is operated so that the camera arm 12 is folded down in line with the stage 11 as shown in FIGS. 6 and 7. In this case, the optical axis of the image-pickup lens is substantially parallel to the stage 11. The lamp arm 38 is then rotated so that the right-hand exterior illumination lamp 14 is folded down on the stage 11.

An area of the stage 11 on which the material is placed can be increased in the above-described visual presentation apparatus 10 since the arm mount 31 is mounted outside the stage. Furthermore, the length of the camera arm 12 can be increased since the camera arm is caused to pivot substantially along the diagonal of the stage 11. Consequently, a distance between the CCD video camera 13 assuming its operating position and the stage 11 is increased and accordingly the shooting area can be increased.

Furthermore, the CCD video camera 13 assuming the position where the optical axis of the image-pickup lens is perpendicular to the stage 11 is rotated to the position where the optical axis is substantially parallel to the stage 11 when the apparatus 10 is folded down. Accordingly, the apparatus 10 can be folded down compactly with the CCD video camera 13 not projecting out of the stage 11 but being adjacent to the stage 11.

Additionally, the illumination switches 16 and 17, zoom buttons 18 and 19, auto-focus button 20, etc. are disposed on the upper front of the stage 11. These switches are frequently used. The less frequently used switches 23 to 29 are disposed on the switch panel 21 accommodated in the recess 22 so as to be drawn out. Consequently, the area of the stage 11 on which the material is placed can further be increased since many switches need not be provided on the upper face of the stage 11.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

We claim:

1. A visual presentation apparatus comprising:
a generally rectangular stage on which a material is placed;
a video camera for obtaining an image of the material;
a camera arm on which the video camera is mounted so that the video camera is located above a central portion of the stage; and
an arm mount provided outside one of corners of the stage, wherein the camera arm having a proximal end pivotally mounted on the arm mount so that the camera arm is caused to pivot substantially along a diagonal of the stage between a first position where the video camera is located above the central portion of the stage and a second position where the camera arm is folded down along the stage, and wherein the video camera is located within the stage when the camera arm assumes the second position.

2. A visual presentation apparatus according to claim 1, wherein the video camera is mounted on the camera arm so as to be rotatable within a plane generally perpendicular to the stage.

3. A visual presentation apparatus according to claim 2, wherein the video camera is mounted on the camera arm so as to be rotatable within a plane generally parallel to the stage.

4. A visual presentation apparatus according to claim 1, further comprising a switch panel provided at a side of the stage, wherein said side of the stage has a recess in which the switch panel is accommodated so as to be drawn out.
